(19) United States
(12) Patent Application Publication
(10) Pub. No.: US 2007/0235484 A1
(43) Pub. Date: Oct. 11, 2007

(54) Article holder/message display unit

(76) Inventor: John T. Staniszewski, Staten Island, NY (US)

Correspondence Address: ANDREW L. NEY, 4 ANDORRA HILL, LAFAYETTE HILL, PA, 19444, US

(21) Appl. No.: 11/390,594

(22) Filed: Mar. 28, 2006

(51) Int. Cl. B60R 7/00; B60R 7/05

(52) U.S. Cl. 224/312; 224/277

(57) ABSTRACT

An article holder/message display unit having one or more article holding compartments and a message panel bearing indicia of a message for viewing. This article holder/message display unit is arranged to be mounted to a visor in a vehicle so that articles can be stored in the article holding compartments by an individual while in the vehicle and a message on the message panel can be viewed by an individual outside the vehicle.

### FIELD OF THE INVENTION

The present invention relates, in general, to the storage of articles and, in particular, to an article holding unit that is used in a vehicle and also provides messages relevant to the vehicle and to the use of the vehicle.

### BACKGROUND OF THE INVENTION

There are several reasons why individuals receive vehicle parking violation tickets besides the intentional or neglectful wrongful parking of a vehicle. In many instances, the driver of the vehicle does not intend to wrongfully park the vehicle. Rather, the driver is a victim of circumstances that could or might have been avoided. Yet, the driver can, and most often does, remain liable to pay the vehicle parking violation ticket. The following are examples:
Municipal parking meter receipts that are placed on the vehicle dashboard are not displayed properly, or roll up, or fall or are blown off the dashboard.
Broken or inoperative parking meters.
The vehicle is disabled and remains parked at a location where parking was legal at the time the vehicle was parked but is wrongful later on.

Special parking permits are displayed improperly or cannot be found because they have been lost or misplaced either somewhere in the vehicle or elsewhere and the loss is discovered only when the vehicle is being parked.

All of the foregoing examples can lead to the appearance of a parking violation that is ticketed. For the most part, the foregoing examples of what may be termed “innocent” or “unintentional” parking violations result from (a) the driver of the vehicle not having the means to give notice that the parking of the vehicle is not wrongful, or (b) the driver failing to use properly the authorization to park the vehicle, or (c) the driver not being able to find evidence of the authorization to park the vehicle.

A driver of a vehicle, therefore, is often likely to be in need of a number of different, readily available articles as he or she operates the vehicle to overcome the problems described above that are associated with parking the vehicle. At the same time, the driver of a vehicle often has in the vehicle many other articles that are needed in connection with the operation of the vehicle. For example, currency preferably is at hand for the driver as tolls must be paid. Likewise, the drivers of vehicles keep vehicle registrations and proofs of vehicle insurance in the vehicle. Vehicle operators also collect receipts for fuel purchases, tolls paid, parking, and vehicle repair and servicing along with other papers or documents.

These and other articles typically are stored, in a somewhat random manner, in center consoles or glove compartments that are built into the vehicle or in separate containers that can be positioned on the floor of the vehicle or elsewhere in the vehicle. Certain vehicles have pouches built into the visors in which articles, such as sunglasses and papers, can be stored.

None of these known article storage arrangements provide adequate solutions to the concurrent and related problems identified above that are associated with vehicle operation and parking and organized storage of articles in vehicles.

### SUMMARY OF THE INVENTION

Accordingly, an article holder/message display unit, constructed in accordance with the present invention, includes a base panel, a pouch panel secured to the base panel along a substantial extent of the perimeter of the pouch panel and forming, with the base panel, an article holding compartment having an opening extending along that portion of the perimeter of the pouch panel not secured to the base panel. Also included in this article holder/message display unit are a message panel bearing indicia of a message for viewing and attachment means for mounting the article holder/message display unit to a visor in a vehicle so that an article can be stored in the article holding compartment by an individual while in the vehicle and a message on the message panel can be viewed by an individual outside the vehicle.

### BRIEF DESCRIPTION OF THE DRAWINGS

FIG. 1 is a front view of a first embodiment of an article holder/message display unit constructed in accordance with the present invention.

FIG. 2 is a front view of a second embodiment of an article holder/message display unit constructed in accordance with the present invention.

FIG. 3 is a rear view of the FIG. 1 and FIG. 2 article holder/message display units.

FIGS. 4A and 4B are front and rear views of a message panel.

FIG. 5 is a sectional view taken along line 5-5 of FIG. 1.

FIG. 6 is a sectional view illustrating a removable article holding compartment.

FIG. 7 is a sectional view taken along line 7-7 of FIG. 3.

### DETAILED DESCRIPTION OF THE INVENTION

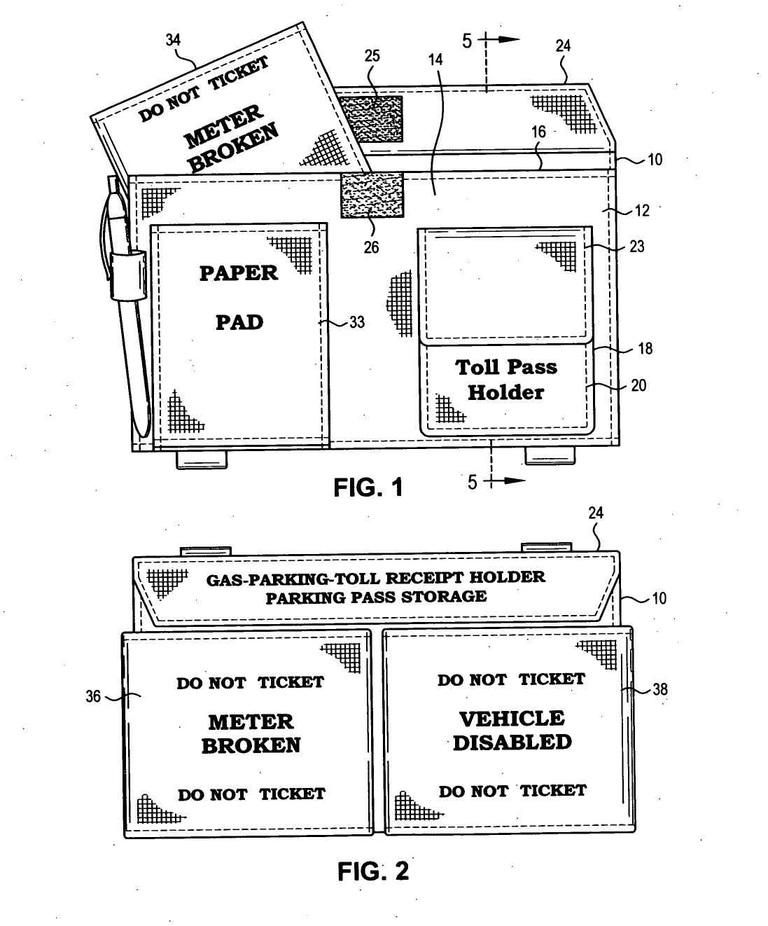

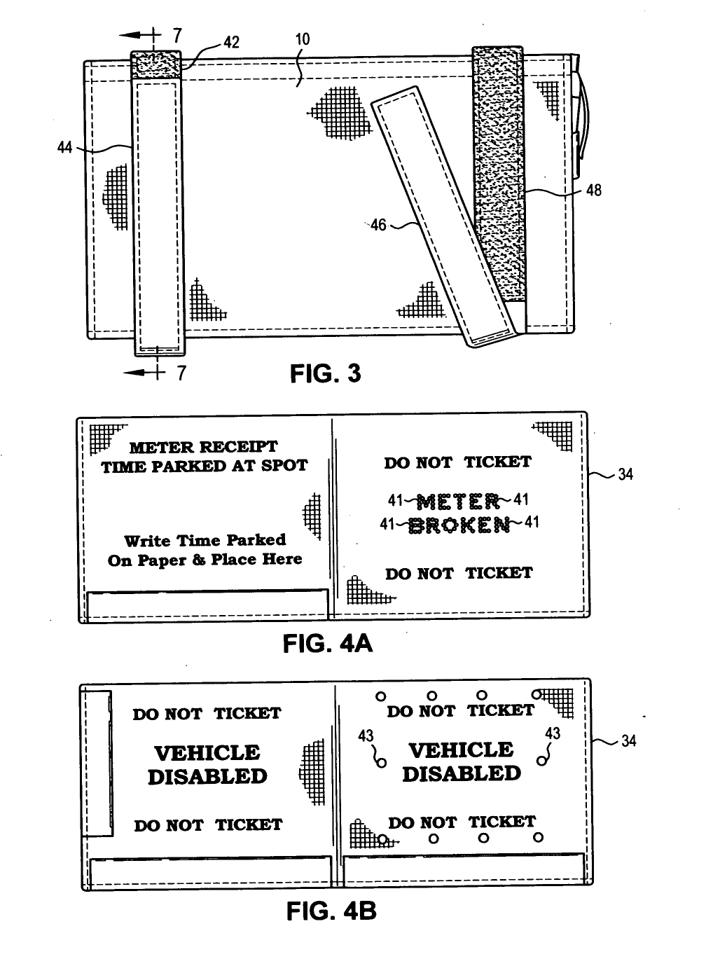

Referring to FIGS. 1, 3, 4A, 4B, 5, and 7, a first embodiment of an article holder/message display unit, constructed in accordance with the present invention, includes a base panel 10 and a pouch panel 12 secured to the base panel along a substantial extent of the perimeter of the pouch panel. Pouch panel 12 and base panel 10 form an article holding compartment 14 having an opening 16 extending along that portion of the perimeter of the pouch panel not secured to the base panel.

An article holder/message display unit, constructed in accordance with the present invention, can have a second article holding compartment, identified by reference numeral 18, that is formed by a second pouch panel 20 secured to pouch panel 12 along a substantial extent of the perimeter of the second pouch panel and having an opening 22, covered by a flap 23 in FIG. 1, extending along that portion of the perimeter of pouch panel 20 not secured to pouch panel 12. It will be apparent that the second pouch panel 20 can be secured directly to base panel 10 if article holding compartment 14 is smaller than illustrated and does not extend over the entire surface area of the base panel.

Base panel 10 preferably is a stiff, rigid member that serves as a base body of an article holder/message display unit constructed in accordance with the present invention. Base panel 10 may include a piece of stiff cardboard covered with a suitable fabric. The pouch panels preferably are pieces of suitable fabric.

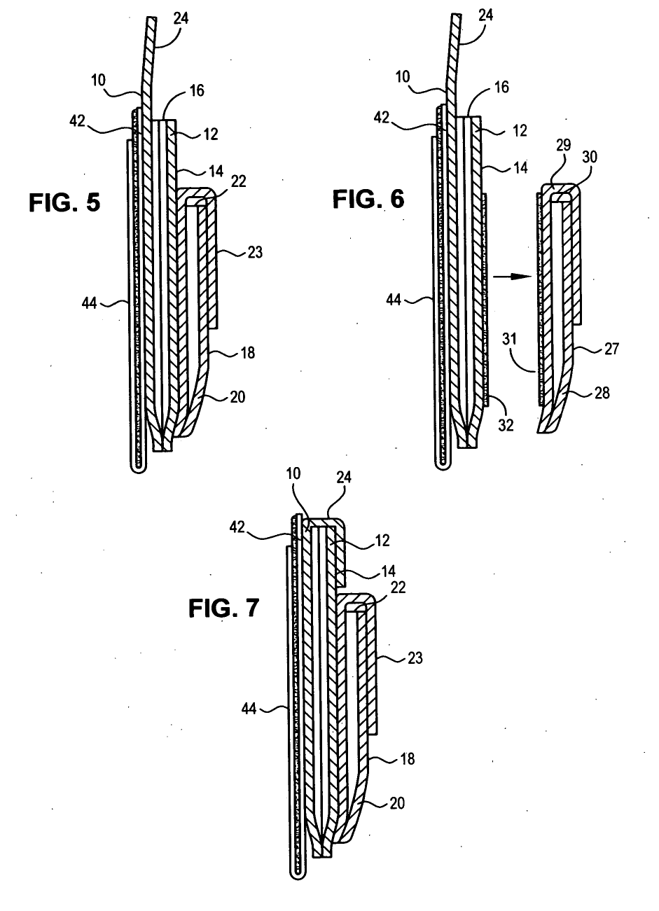

As shown in FIGS. 1 and 5 and also in FIG. 2, article holding compartment 14 can have a flap 24 secured to base panel 10 along opening 16 for closing the article holding compartment when the flap is secured to pouch panel 12. Closure of article holding compartment 14 can be accomplished by suitable fastening means provided on flap 24 and pouch panel 12. Such fastening means can take various forms such as, for example, snap fasteners or, as illustrated, hook and loop tape 25 and 26, such as VELCRO, disposed on flap 24 and pouch panel 12, respectively.

As indicated most clearly by a comparison of FIGS. 5 and 6, the article holding compartments can be formed in two ways. FIG. 5 illustrates forming the article holding compartments by securing a pouch panel 12 to the base panel 10 along a substantial extent of the perimeter of the pouch panel and having an opening 16 extending along that portion of the perimeter of the pouch panel not secured to the base panel.

In FIG. 6, an article holding compartment 27 has a pair of pouch panels 28 and 29 secured together along a substantial extent of the perimeters of the pouch panels and having an opening 30 extending along those portions of the perimeter of the pouch panels not secured together. Article holding compartment 27 can, in turn, be removably attached to pouch panel 12 as illustrated or directly to base panel 10 if article holding compartment 14 is smaller than as illustrated and does not extend over the entire surface area of the base panel. The removable attachment of article holding compartment 27 to either pouch panel 12 or base panel 10 can be done in various ways such as, for example, snap fasteners or, as illustrated, hook and loop tapes 31 and 32, such as VELCRO, disposed on pouch panel 29 and pouch panel 12, respectively. This feature of a removable article holding compartment permits a user of the article holder/message display unit to carry away a portion of the unit without the need to remove the entire unit from a vehicle in which the unit is mounted.

As illustrated in FIG. 1, by the marking “PAPER PAD” on an article holding compartment 33 and the marking “Toll Pass Holder” on article holding compartment 18, the article holding compartments can have indicia that identify the types of articles that can be stored, in an organized manner, in the article holding compartments.

An article holder/message, display unit, constructed in accordance with the present invention, further includes a message panel bearing indicia of a message (e.g., “DO NOT TICKET VEHICLE DISABLED DO NOT TICKET”) for viewing by an individual outside the vehicle. For the embodiment of the present invention illustrated in FIG. 1, the message panel is a separate component 34 from the other components of the article holder/message display unit and is stored in an article holding compartment, as illustrated in FIG. 1 for example, when not in use for viewing by an individual outside the vehicle. Message panel 34 is made to have sufficient weight and rigidity so that, when placed on the dashboard of the vehicle, it will remain in place and not be blown off the dashboard or inadvertently pushed off the dashboard.

FIG. 2 illustrates a second embodiment of an article holder/message display unit constructed in accordance with the present invention. In this embodiment of the present invention, the message panel is not a separate component. Rather, the message panel is mounted to the base panel for pivotal swinging movement relative to base panel. In particular, two message panels 36 and 38 are mounted to opposite side edges of base panel 10 for pivotal swinging movement relative to the base panel. Each of the message panels 36 and 38 bear indicia of a message (e.g., “DO NOT TICKET METER BROKEN DO NOT TICKET” on message panel; 36 and “DO NOT TICKET VEHICLE DISABLED DO NOT TICKET” on message panel 38) for viewing by an individual outside the vehicle. Message panels 36 and 38 are shown in the closed position in FIG. 2 and are held in the closed position by suitable means (e.g., hook and loop tape) that are not shown. With the article holder/message display unit mounted on the back side of a visor, a message panel is made viewable from outside the vehicle by swinging the visor down, releasing the message panel from the closed position, and swinging the message panel outward.

To enhance the viewing of the messages indicia on the message panels (e.g., “DO NOT TICKET METER BROKEN DO NOT TICKET” on message panel 36 in FIG. 2) and the markings indicia on the holding compartments (e.g., “Toll Pass Holder” on pouch panel 2 in FIG. 1), a special ink that glows may be used to present the messages indicia and the markings indicia. This feature is especially desirable under conditions of complete darkness or near complete darkness. There are many commercially available Luminescent, Phosphorescent, Photo luminescent, Fluorescent, Chemiluminescent, Bioluminescent, and Electroluminescent inks that can be used for this purpose.

Instead of using an ink that glows, light sources, such as light diodes, can be arranged as the messages indicia and the markings indicia to enhance the viewing of the messages indicia and the markings indicia. Many such light sources, battery powered or solar powered, are commercially available that can serve this purpose. The “METER BROKEN” portion of the messages indicia in FIG. 4A, composed of a plurality of light sources 41 illustrates such an arrangement.

Yet another way of enhancing the viewing of the messages indicia and the markings indicia is by positioning a plurality of light sources in proximity to the messages indicia and the markings indicia that cast light on the messages indicia and markings indicia. Such light devices can be arranged to surround and cast light on the indicia as illustrated in FIG. 4B by a plurality of light sources 43 that surround and cast light on the message indicia “DO NOT TICKET VEHICLE DISABLED DO NOT TICKET” on message panel 34 or to surround and cast light on the individual characters or words in the messages indicia and markings indicia. Light devices 43 can be arranged to flash or remain on steadily.

An article holder/message display unit, constructed in accordance with the present invention, also includes means for mounting the article holder/message display unit to a visor in a vehicle so that an article can be stored in an article holding compartment by an individual while in the vehicle and a message on the message panel can be viewed by an individual outside the vehicle. Such means include, for the embodiments of the invention illustrated, two pairs of straps 42, 44 and 46, 48, with each strap having suitable fastening means at the ends of the straps for attaching the ends of the straps together. Such fastening means can take various forms such as, for example, snap fasteners or hook and loop tapes, such as VELCRO, that extend along selected lengths of the straps 42, 44, 46, and 48, so that after the article holder/message display unit has been positioned against the visor and the hook and loop tape sections of the straps of are brought together, the article holder/message display unit will be mounted to the visor.

While preferred embodiments of the present invention have been shown and described herein, it will be understood that such embodiments are provided by way of examples only. Numerous variations, changes and substitutions will occur to those skilled in the art without departing from the spirit of the invention. Accordingly, it is intended that the appended claims cover such variations as fall within the spirit and scope of the invention.

What is claimed:

1. An article holder/message display unit comprising:
a base panel;
a pouch panel secured to said base panel along a substantial extent of the perimeter of said pouch panel and forming, with said base panel, an article holding compartment having an opening extending along that portion of the perimeter of said pouch panel not secured to said base panel;
a message panel bearing indicia of a message for viewing; and
attachment means for mounting said article holder/message display unit to a visor in a vehicle so that:
(a) an article can be stored in said article holding compartment by an individual while in the vehicle, and
(b) a message on said message panel can be viewed by an individual outside the vehicle.

2. An article holder/message display unit according to claim 1 wherein said message panel is a separate component from other components of said article holder/message display unit and is stored in said article holder/message display unit when not in use for viewing by an individual outside the vehicle.

3. An article holder/message display unit according to claim 2 further comprising:
(a) a second pouch panel secured to the first mentioned pouch panel along a substantial extent of the perimeter of said second pouch panel and forming with said first mentioned pouch panel a second article holding compartment having an opening extending along that portion of the perimeter of said second pouch panel not secured to said first mentioned pouch panel, and
(b) a flap secured to said base panel along said opening in the first mentioned article holding compartment.

4. An article holder/message display unit according to claim 1 wherein said message panel is mounted to said base panel for pivotal swinging movement relative to said base panel.

5. An article holder/message display unit according to claim 4 further comprising:
(a) a second pouch panel secured to the first mentioned pouch panel along a substantial extent of the perimeter of said second pouch panel and forming with said first mentioned pouch panel a second article holding compartment having an opening extending along that portion of the perimeter of said second pouch panel not secured to said first mentioned pouch panel, and
(b) a flap secured to the first mentioned pouch panel along said opening in said second article holding compartment.

6. An article holder/message display unit comprising:
a base panel;
a plurality of article holding compartments;
a message panel bearing indicia of a message for viewing; and
means for mounting said article holder/message display unit to a visor in a vehicle so that:
(a) articles can be stored in said article holding compartments by an individual while in the vehicle, and
(b) a message on said message panel can be viewed by an individual outside the vehicle.

7. An article holder/message display unit according to claim 6 wherein:
(a) a first of said article holding compartments is formed by a first pouch panel secured to said base panel along a substantial extent of the perimeter of said first pouch panel and having an opening extending along that portion of the perimeter of said first pouch panel not secured to said base panel, and
(b) a second of said article holding compartments is formed by a second pouch panel secured to said first pouch panel along a substantial extent of the perimeter of said second pouch panel and having an opening extending along that portion of the perimeter of said second pouch panel not secured to said first pouch panel.

8. An article holder/message display unit according to claim 6 wherein:
(a) a first of said article holding compartments is formed by a first pouch panel secured to said base panel along a substantial extent of the perimeter of said first pouch panel and having an opening extending along that portion of the perimeter of said first pouch panel not secured to said base panel, and
(b) at least one of said article holding compartments:
(1) includes second and third pouch panels secured together along a substantial extent of the perimeters of said second and third pouch panels,
(2) has an opening extending along those portions of the perimeters of said second and third pouch panels not secured together, and
(3) is removably attached to one of said base panel and said first pouch panel.

9. An article holder/message display unit according to claim 3 wherein said base panel is rigid and said pouch panels are flexible.

10. An article holder/message display unit according to claim 5 wherein said base panel is rigid and said pouch panels are flexible.

11. An article holder/message display unit according to claim 6 wherein said base panel is rigid.

12. An article holder/message display unit according to claim 7 wherein said base panel is rigid and said pouch panels are flexible.

13. An article holder/message display unit according to claim 8 wherein said base panel is rigid and said pouch panels are flexible.

14. An article holder/message display unit according to claim 9 wherein said attachment means include two pairs of straps with each strap having a length of hook and loop tape adapted to overlap the length of hook and tape of the other strap of the pair of straps.

15. An article holder/message display unit according to claim 10 wherein said attachment means include two pairs of straps with each strap having a length of hook and loop tape adapted to overlap the length of hook and tape of the other strap of the pair of straps.

16. An article holder/message display unit according to claim 12 wherein said attachment means include two pairs of straps with each strap having a length of hook and loop tape adapted to overlap the length of hook and tape of the other strap of the pair of straps.

17. An article holder/message display unit according to claim 13 wherein said attachment means include two pairs of straps with each strap having a length of hook and loop tape adapted to overlap the length of hook and tape of the other strap of the pair of straps.

18. An article holder/message display unit according to claim 7 wherein said message panel is a separate component from other components of said article holder/message display unit and is stored in said article holder/message display unit when not in use for viewing by an individual outside the vehicle.

19. An article holder/message display unit according to claim 8 wherein said message panel is a separate component from other components of said article holder/message display unit and is stored in said article holder/message display unit when not in use for viewing by an individual outside the vehicle.

20. An article holder/message display unit according to claim 7 wherein said message panel is mounted to said base panel for pivotal swinging movement relative to said base panel.

21. An article holder/message display unit according to claim 8 wherein said message panel is mounted to said base panel for pivotal swinging movement relative to said base panel.

22. An article holder/message display unit according to claim 8 wherein:
(a) one of said base panel and said first pouch panel has a first length of hook and loop tape, and
(b) said second pouch panel has a second length of hook and loop tape overlapping said first length of hook and loop tape.

23. An article holder/message display unit according to claim 1 wherein said indicia of a message is presented in ink that glows.

24. An article holder/message display unit according to claim 1 wherein said indicia of a message includes a plurality of light source arranged as said indicia of a message.

25. An article holder/message display unit according to claim 1 further including a plurality of light sources positioned in proximity to said indicia of a message to cast light on said indicia of a message.

26. An article holder/message display unit according to claim 23 further including indicia on said pouch panel that identifies the type of article stored in said article holder/message display unit and said indicia on said pouch panel is presented in ink that glows

27. An article holder/message display unit according to claim 24 further including indicia on said pouch panel that identifies the type of article stored in said article holder/message display unit and said indicia on said pouch panel includes a plurality of light source arranged as said indicia on said pouch panel.

28. An article holder/message display unit according to claim 25 further including indicia on said pouch panel that identifies the type of article stored in said article holder/message display unit and said article holder/message display unit further includes a plurality of light devices positioned in proximity to said indicia on said pouch panel to cast light on said indicia on said pouch panel.
